(19) United States
(12) Patent Application Publication
(10) Pub. No.: US 2026/0062054 A1
(43) Pub. Date: Mar. 5, 2026

(54) CONTROL DEVICE, CONTROL METHOD, AND NON-TRANSITORY COMPUTER-READABLE STORAGE MEDIUM

(71) Applicant: HONDA MOTOR CO., LTD., Tokyo (JP)

(72) Inventor: Osamu TAKAHATA, Tokyo (JP)

(73) Assignee: HONDA MOTOR CO., LTD., Tokyo (JP)

(21) Appl. No.: 19/308,837

(22) Filed: Aug. 25, 2025

(30) Foreign Application Priority Data
Aug. 30, 2024 (JP) 2024-148544

(51) Int. Cl. B62D 15/02; B60K 35/28; B60W 50/14; B62D 13/06

(52) U.S. Cl. CPC B62D 15/0275; B60K 35/28; B60W 50/14; B62D 13/06; B60K 2360/173; B60K 2360/176; B60K 2360/1868; B60W 2050/146; B60W 2300/14

(57) ABSTRACT

A control device has a processor which acquires external environment information of a towing vehicle towing a towed vehicle, and controls to display a guidance route image showing a guidance route for at least one of the towing vehicle and the towed vehicle, the guidance route image being superimposed on a peripheral image of the towing vehicle based on the external environment information. The processor controls a superposition mode of the guidance route image to be different between a first range of the peripheral image in which the towed vehicle is displayed and a second range of the peripheral image excluding the first range.

### CROSS-REFERENCE TO RELATED APPLICATIONS

This application is based on and claims priority under 35 USC 119 from Japanese Patent Application No. 2024-148544 filed on Aug. 30, 2024, the entire content of which is incorporated herein by reference.

### TECHNICAL FIELD

The present disclosure relates to a control device, a control method, and a non-transitory computer-readable storage medium storing a control program.

### BACKGROUND ART

In recent years, active efforts have been made to provide access to a sustainable transportation system in consideration of vulnerable people among traffic participants. In order to implement the above, focus has been placed on research and development on further improving safety and convenience of traffic by research and development related to autonomous driving techniques.

In the related art, there is a known technique for displaying a guide line, which shows a predicted traveling region of a vehicle based on a vehicle traveling state, superimposed on a vehicle peripheral image when the vehicle is traveling or turning. For example, JP2019-069717A describes a parking assistance device including an image processing unit that generates a peripheral image showing a surrounding situation of a towing vehicle based on an imaging result of an imaging unit provided in the towing vehicle, a route acquisition unit that, when a target parking position for a towed vehicle coupled to the towing vehicle is set, acquires a guidance route that extends from the target parking position as a starting point for guiding the towed vehicle to the target parking position, and a display processing unit that, when the guidance route is acquired, displays the guidance route superimposed on the peripheral image, in which the target parking position includes a pair of target positions that correspond to a vehicle width of the towed vehicle, and the display processing unit displays the guidance route that extends from at least one of the pair of target positions that is on a turning inner side of the towing vehicle, superimposed on the peripheral image.

However, when the guidance route is displayed superimposed on the peripheral image, the guidance route is also displayed superimposed on the image of the towed vehicle, and therefore, there are drawbacks such as reduced visibility of the towed vehicle and the guidance route for a driver, and discomfort due to displaying of the guidance route on the towed vehicle. However, JP2019-069717A has no description about the guidance route displayed superimposed on the towed vehicle. Therefore, there is room for improvement in a way of displaying a guidance route for a towing vehicle which tows a towed vehicle.

### SUMMARY OF INVENTION

An object of the present disclosure is to provide a control device, a control method, and a non-transitory computer-readable storage medium storing a control program that enable to reduce discomfort when a guidance route image is displayed in a superimposed manner.

This hence contributes to development of a sustainable transportation system.

A first aspect of the present disclosure relates to a control device, having a processor configured to:
acquire external environment information of a towing vehicle towing a towed vehicle; and
control to display a guidance route image showing a guidance route for at least one of the towing vehicle and the towed vehicle, the guidance route image being superimposed on a peripheral image of the towing vehicle based on the external environment information, in which
the processor controls a superposition mode of the guidance route image to be different between a first range of the peripheral image in which the towed vehicle is displayed and a second range of the peripheral image excluding the first range.

A second aspect of the present disclosure relates to a control method, in which
a processor of a control device is configured to:
   acquire external environment information of a towing vehicle towing a towed vehicle;
   control to display a guidance route image showing a guidance route for at least one of the towing vehicle and the towed vehicle, the guidance route image being superimposed on a peripheral image of the towing vehicle based on the external environment information; and
   control a superposition mode of the guidance route image to be different between a first range of the peripheral image in which the towed vehicle is displayed and a second range of the peripheral image excluding the first range.

A third aspect of the present disclosure relates to a non-transitory computer-readable storage medium storing a control program that causes a processor of a control device to:
acquire external environment information of a towing vehicle towing a towed vehicle;
control to display a guidance route image showing a guidance route for at least one of the towing vehicle and the towed vehicle, the guidance route image being superimposed on a peripheral image of the towing vehicle based on the external environment information; and
control a superposition mode of the guidance route image to be different between a first range of the peripheral image in which the towed vehicle is displayed and a second range of the peripheral image excluding the first range.

According to the aspects of the present disclosure, it is possible to provide the control device, the control method, and the non-transitory computer-readable storage medium storing the control program that enable to reduce discomfort when the guidance route image is displayed in the superimposed manner.

### BRIEF DESCRIPTION OF DRAWINGS

Exemplary embodiment(s) of the present invention will be described in detail based on the following figures, in which:

FIG. 1 is a side view of an example of a vehicle equipped with a control device of the present disclosure;

FIG. 2 is a top view of the vehicle illustrated in FIG. 1;

FIG. 3 is a block diagram illustrating an example of an internal configuration of the vehicle illustrated in FIG. 1;

FIG. 4 is a diagram illustrating an example of a guidance route image displayed on a peripheral image of a vehicle 10;

FIG. 5 is a diagram illustrating an example of generation of a rear image 5a illustrated in FIG. 4;

FIG. 6 is a flowchart illustrating an example of display processing for the rear image when the vehicle 10 travels backward;

FIG. 7 is a flowchart illustrating a modification of the display processing of the rear image when the vehicle 10 travels backward; and

FIG. 8 is a diagram illustrating a modification of the generation of the rear image 5a illustrated in FIG. 4.

### DESCRIPTION OF EMBODIMENTS

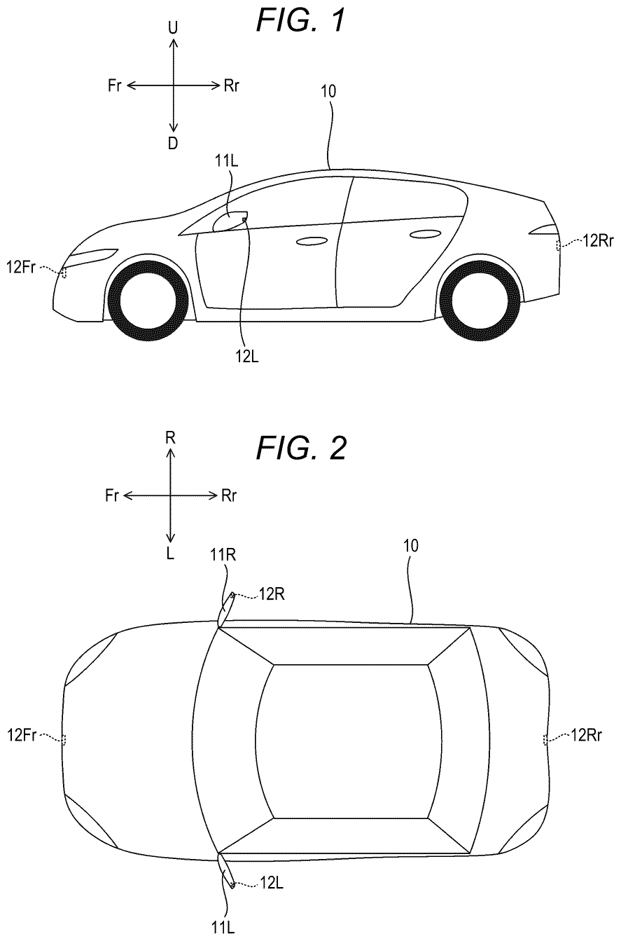

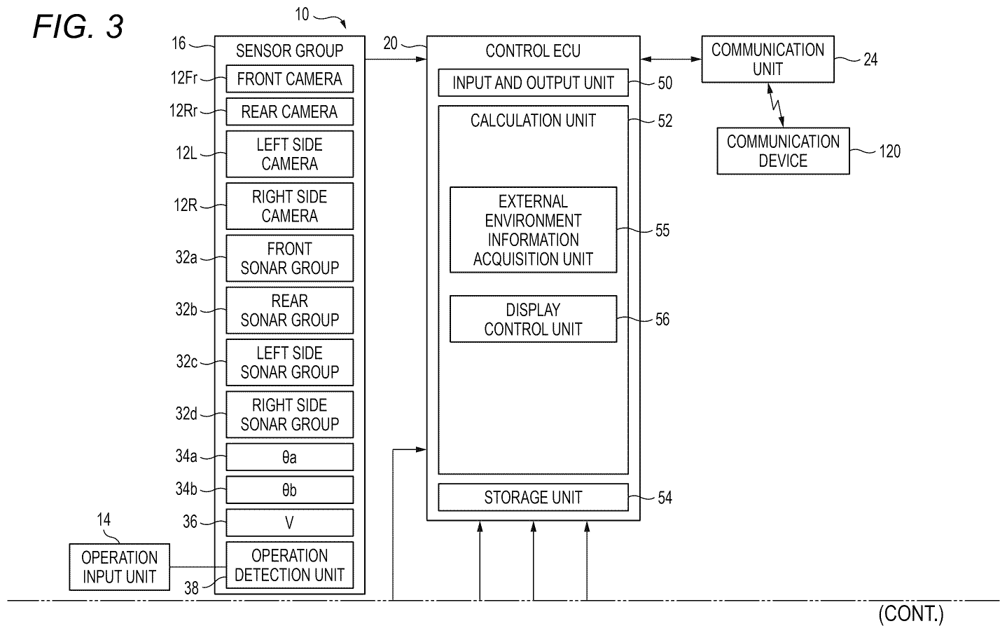

Hereinafter, an embodiment of a control device, a control method, and a control program of the present disclosure will be described with reference to the accompanying drawings. The drawings are viewed in directions of reference numerals. In order to simplify and clarify the description in the present specification or the like, a front-rear direction, a left-right direction, and an upper-lower direction are described according to directions viewed from a driver of a vehicle 10 shown in FIGS. 1 and 2. In the drawings, a front side of the vehicle 10 is shown as Fr, a rear side is shown as Rr, a left side is shown as L, a right side is shown as R, an upper side is shown as U, and a lower side is shown as D.

### Vehicle 10 Equipped with Control Device

FIG. 1 is a side view of an example of a vehicle equipped with the control device of the present disclosure. FIG. 2 is a top view of the vehicle illustrated in FIG. 1. The vehicle 10 is an example of a “towing vehicle” of the present disclosure.

The vehicle 10 is an automobile including a drive source (not shown) and wheels including drive wheels driven by power of the drive source and steerable steered wheels. In the present embodiment, the vehicle 10 is a four-wheeled automobile including a pair of left and right front wheels and a pair of left and right rear wheels. The vehicle 10 is, for example, an automobile capable of towing a trailer or the like. The drive source of the vehicle 10 is, for example, an electric motor. The drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by rotating about the rotation shafts.

The vehicle 10 further includes a front camera 12Fr, a rear camera 12Rr, a left side camera 12L, and a right side camera 12R. The front camera 12Fr is an imaging device (for example, a digital camera) that is provided on the front side of the vehicle 10 and captures an image in a forward direction of the vehicle 10. The rear camera 12Rr is a digital camera that is provided on the rear side of the vehicle 10 and captures an image in a rearward direction of the vehicle 10. The left side camera 12L is a digital camera that is provided on the left side mirror 11L of the vehicle 10 and captures an image in a leftward direction of the vehicle 10. The right side camera 12R is a digital camera that is provided on the right side mirror 11R of the vehicle 10 and captures an image in a rightward direction of the vehicle 10.

### Internal Configuration of Vehicle 10

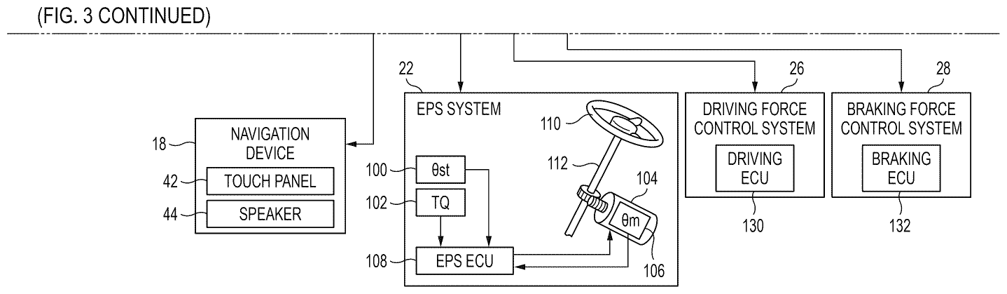

FIG. 3 is a block diagram illustrating an example of an internal configuration of the vehicle illustrated in FIG. 1. As illustrated in FIG. 3, the vehicle 10 includes a sensor group 16, a navigation device 18, a control electronic control unit (ECU) 20, an electric power steering (EPS) system 22, and a communication unit 24. The vehicle 10 includes a driving force control system 26 and a braking force control system 28.

The sensor group 16 acquires various detection values used for control by the control ECU 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38.

The front camera 12Fr, the rear camera 12Rr, the left side camera 12L, and the right side camera 12R acquire an external environment image for recognizing the vehicle 10 and an external environment of the vehicle 10 by imaging the external environment of the vehicle 10. Peripheral images of the vehicle 10 captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a lateral side image. An image of the vehicle 10 and the periphery of the vehicle, which is generated by combining the images captured by the front camera 12Fr, the rear camera 12Rr, the left side camera 12L, and the right side camera 12R, is referred to as a top view image of the vehicle 10.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a transmission countershaft. Note that the sensor group 16 may also include, for example, an object detection sensor capable of detecting objects in the periphery of the vehicle 10. The objects include a trailer connected to (towed by) the vehicle 10, other vehicles present in the periphery of the vehicle, and the like. The object detection sensor includes, for example, a radar, light detection and ranging or laser imaging detection and ranging (Lidar), a sonar, a yaw rate sensor, a magnetic sensor, and a steering angle sensor.

The operation detection unit 38 detects an operation content of a user performed using an operation input unit 14, and outputs the detected operation content to the control ECU 20. The operation input unit 14 includes various user interfaces such as a side mirror switch that switches between opened and closed states of the side mirrors 11L and 11R, and a shift lever (a selector lever or a selector).

The navigation device 18 detects a current position of the vehicle 10 by using, for example, a global positioning system (GPS), and guides the user along a route to a destination. The navigation device 18 includes a storage device (not illustrated) including a map information database.

The navigation device 18 includes a touch panel 42 and a speaker 44. The touch panel 42 functions as an input device and a display device of the control ECU 20. The speaker 44 outputs various types of guidance information to the user of the vehicle 10 by voice.

The touch panel 42 enables input of various commands to the control ECU 20. For example, the user may input a command related to movement assistance of the vehicle 10 via the touch panel 42. The movement assistance includes parking assistance and exiting assistance of the vehicle 10. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes an automated parking button for requesting parking by automatic steering of the control ECU 20, and a parking support button for requesting support while parking the vehicle by an operation of the user. The exiting assistance button includes an automated exiting button for requesting exiting by the automatic steering of the control ECU 20, and an exiting support button for requesting support while exiting by an operation of the user. For example, the touch panel 42 displays the top view image generated by combining the images captured by the front camera 12Fr, the rear camera 12Rr, the left side camera 12L, and the right side camera 12R. Note that a constituent element other than the touch panel 42, for example, an information terminal such as a smartphone or a tablet may be used as the input device or the display device.

The control ECU 20 includes an input and output unit 50, a calculation unit 52, and a storage unit 54. The calculation unit 52 is implemented by, for example, a central processing unit (CPU). The calculation unit 52 executes various types of control by controlling units based on a program stored in the storage unit 54. The calculation unit 52 receives and outputs signals from and to each unit connected to the control ECU 20 via the input and output unit 50. The control ECU 20 is an example of a “control device” in the present disclosure.

The calculation unit 52 includes an external environment information acquisition unit 55 and a display control unit 56.

The external environment information acquisition unit 55 acquires external environment images of the vehicle 10 captured by the front camera 12Fr, the rear camera 12Rr, the left side camera 12L, and the right side camera 12R from the cameras. The external environment information acquisition unit 55 acquires external environment information of the vehicle 10 towing a trailer based on the external environment images acquired from the cameras. The “external environment information of the vehicle 10 towing the trailer” also includes information on the trailer based on captured images of the trailer.

The display control unit 56 displays a peripheral image of the vehicle 10 based on the external environment information acquired by the external environment information acquisition unit 55. The “peripheral image” includes the top view image, the rear image, the left side image, the right side image, and the like. The peripheral image may include not only the images of the periphery but also an image of the vehicle 10 (for example, an image of the vehicle 10 in the top view image). The peripheral image may also be generated by combining a plurality of pieces of external environment information.

The display control unit 56 displays a guidance route image showing a guidance route for at least one of the vehicle 10 and the trailer towed by the vehicle 10 superimposed on the peripheral image of the vehicle 10. The guidance route is a route from the current position of at least one of the vehicle 10 and the trailer to a target parking position of at least one of the vehicle 10 and the trailer. The route from the current position to the target parking position may be, for example, a route from the current position of the vehicle 10 to the target parking position of the vehicle 10, or a route from the current position of the trailer to the target parking position of the trailer, or a route from the current position of the vehicle 10 and the trailer to the target parking position of the vehicle 10 and the trailer. The “target parking position” is configured to be set by the user for example, and may be a parking position set by the user. The “target parking position” may be, for example, a parking position that is set by the vehicle 10 automatically searching for an empty parking position (target parking position).

The guidance route is a route calculated based on specification information of the trailer and a relative angle between the vehicle 10 and the trailer. The specification information of the trailer includes, for example, a shape (including size) of the trailer, positions of wheels of the trailer, and the like. The relative angle refers to, for example, a hitch angle of a hitch ball that couples the vehicle 10 to the trailer. The guidance route may be calculated in consideration of a traveling direction of the vehicle 10 towing the trailer. The traveling direction is a direction in which the vehicle 10 towing the trailer is caused to travel, and is a direction that the user can select within a range of, for example, −30 degrees to +30 degrees. The guidance route is, for example, a guidance route in a case where a gear position of the vehicle 10 towing the trailer is set to Reverse to travel backward.

In the peripheral image of the vehicle 10, the display control unit 56 displays a range in which the towed trailer is displayed as a first range of the peripheral image, and displays a range excluding the first range as a second range of the peripheral image. The display control unit 56 controls a superposition mode of the displayed guidance route image to be different between the first range and the second range. The “superposition mode” includes, for example, a no-superposition mode and a superposition mode with a transmittance of 100%. The display control unit 56 superimposes the guidance route image on the first range in a mode such that a visibility of the guidance route image in the first range is lower than a visibility of the guidance route image in the second range. The “mode such that . . . lower than . . . ” means, for example, a mode in which the guidance route image in the first range is not superimposed, or a mode in which the guidance route image displayed in the first range is superimposed with a higher transmittance than the guidance route image displayed in the second range. For example, the guidance route image in the first range may be superimposed after the peripheral image (image with a transmittance of 0%). The display control unit 56 may control not to display the guidance route image in the first range.

The display control unit 56 specifies the first range based on a change amount in each region of the peripheral image. The “change amount in each region” may be, for example, a change amount in each pixel, or a change amount in a plurality of blocks (a plurality of pixels within a block) obtained by dividing the peripheral image. The “change amount” refers to a change amount in a pixel value per unit time. The display control unit 56 specifies, for example, a region in which the change amount per unit time is a predetermined value or less as the first range in which the trailer is displayed. The display control unit 56 determines that a region in which the change amount per unit time is greater than a predetermined value is a display other than the trailer, for example, a display of a background around the trailer, and specifies this area as the second range excluding the first range. The display control unit 56 repeatedly calculates the “change amount” while the vehicle 10 is traveling, and updates the first range based on a calculation result.

The display control unit 56 specifies the first range based on the relative angle between the vehicle 10 and the trailer. The “relative angle” is detected, for example, by a sensor (various types of sensors such as mechanical and optical sensors) capable of detecting the hitch angle. The “relative angle” may be detected, for example, by image recognition of a coupling portion (hitch ball) at a fixed position within the peripheral image.

The vehicle 10 is provided with correspondence information between the relative angle between the vehicle 10 and the trailer and the first range in which the trailer is displayed at that relative angle, that is, information that enables the first range to be derived from the relative angle. The correspondence information may be provided, for example, as a table, or may be provided as a trained model that uses the relative angle as an input and the first range as an output. The correspondence information is created, for example, by detecting the hitch angle with a sensor during traveling of the vehicle 10 while specifying the first range based on the change amount in each region of the peripheral image. The traveling of the vehicle 10 may be actual traveling of the vehicle 10, or may be traveling for calibration of the vehicle 10. Input information for the correspondence information may include the specification information of the trailer in addition to the relative angle.

The display control unit 56 repeatedly specifies the first range in which the trailer is displayed and the second range excluding the first range, for example, while the vehicle 10 is traveling, and updates the first range and the second range to new ranges.

The calculation unit 52 performs automated parking assistance and automated exiting assistance of the vehicle 10 by the automatic steering for automatically operating a steering 110 under control of the calculation unit 52. In the automated parking assistance and the automated exiting assistance, an accelerator pedal (not illustrated), a brake pedal (not illustrated), and the operation input unit 14 are automatically operated. The calculation unit 52 performs parking support assistance and exiting support assistance when the user (driver) operates the accelerator pedal, the brake pedal, and the operation input unit 14 to perform manual parking and manual exiting of the vehicle 10. Note that during the automated parking assistance and the automated exiting assistance, the user may be in the vehicle 10, or may be in a state in which the user has gotten off the vehicle 10 and is in outside.

For example, the calculation unit 52 performs movement control for executing movement of the vehicle 10 based on the external environment image of the vehicle 10 acquired by the front camera 12Fr, the rear camera 12Rr, the left side camera 12L, and the right side camera 12R, and a parking space designated by the user. The movement control includes parking control for automatically parking the vehicle 10 in a predetermined parking space (target parking position) and exiting control for causing the vehicle 10 to automatically exit a predetermined parking space to a target movement position. The calculation unit 52 can execute the parking control and the exiting control according to an instruction signal input from outside via the input and output unit 50. The input from the outside includes input via wireless communication from an information terminal or the like that is portable by the user of the vehicle 10. The calculation unit 52 can transmit information related to the parking control and the exiting control to the external information terminal via the input and output unit 50.

The EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering 110, thereby providing assistance for an occupant's operation on the steering 110 and enabling automatic steering during the parking assistance. The resolver 106 detects a rotation angle θm of the EPS motor 104. The EPS ECU 108 controls the entire EPS system 22. The EPS ECU 108 includes an input and output unit (not illustrated), a calculation unit (not illustrated), and a storage unit (not illustrated).

The communication unit 24 enables wireless communication with the other communication device 120. The other communication device 120 includes a base station, a communication device of another vehicle, or an information terminal such as a smartphone or a tablet terminal portable by the user of the vehicle 10. For example, the communication unit 24 includes an ultra wide band (UWB, registered trademark) interface for performing UWB communication with the information terminal.

The driving force control system 26 includes a driving ECU 130. The driving force control system 26 executes driving force control of the vehicle 10. The driving ECU 130 controls the driving force of the vehicle 10 by controlling an engine or the like (not illustrated) based on an operation performed by the user on the accelerator pedal (not illustrated).

The braking force control system 28 includes a braking ECU 132. The braking force control system 28 executes braking force control of the vehicle 10. The braking ECU 132 controls a braking force of the vehicle 10 by controlling a braking mechanism or the like (not illustrated) based on an operation performed by the user on the brake pedal (not illustrated).

### Display Example of Guidance Route Image

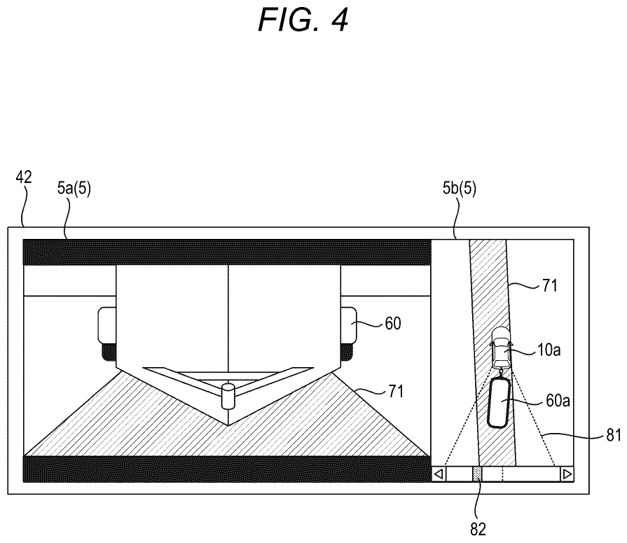

FIG. 4 is a diagram illustrating an example of the guidance route image displayed on the peripheral image of the vehicle 10. As shown in FIG. 4, in the peripheral image 5 of the vehicle 10, for example, a rear image 5a and a top view image 5b are displayed side by side. The rear image 5a and the top view image 5b are images that are displayed when the gear position of the vehicle 10 is in Reverse. The rear image 5a and the top view image 5b are displayed on the touch panel 42 of the navigation device 18, for example. Note that in the present example, both the rear image 5a and the top view image 5b are displayed, but there may be a case where only the rear image 5a is displayed.

The rear image 5a is an image captured by the rear camera 12Rr of the vehicle 10, for example. A captured image of a trailer 60 towed by the vehicle 10 and a guidance route image 71 showing a guidance route for the vehicle 10 and the trailer 60 are displayed superimposed on the rear image 5a. The trailer 60 is an example of the “towed vehicle” of the present disclosure. The guidance route is, for example, a route that guides the vehicle 10 and the trailer 60 to a target parking position.

In the rear image 5a, the guidance route image 71 is not displayed superimposed on a region in which the trailer 60 is displayed (first range), but is displayed superimposed on a region excluding the image of the trailer 60 (second range). In the rear image 5a of the present example, the guidance route image 71 is displayed superimposed on a region between the vehicle 10 and the trailer 60. On the rear image 5a, a message image to the user, such as “Please drive the vehicle backward slowly” or “Please check your surroundings directly”, is displayed.

The top view image 5b is, for example, an image captured by the front camera 12Fr, the rear camera 12Rr, the left side camera 12L, and the right side camera 12R. The vehicle 10 towing the trailer 60 is displayed in the top view image 5b. However, the vehicle displayed in the top view image 5b is an “image of the vehicle 10″ created by the display control unit 56. In the following description, the ”image of the vehicle 10″ in the top view image 5b will simply be referred to as a vehicle 10a. The trailer 60 displayed in the top view image 5b is also an “image of the trailer 60″ created by the display control unit 56. In the following description, the ”image of the trailer 60″ in the top view image 5b will simply be referred to as a trailer 60a.

The guidance route image 71 showing the guidance route for the vehicle 10a and the trailer 60a and a visual field range 81 of the rear image captured by the rear camera 12Rr of the vehicle 10 are displayed superimposed on the top view image 5b. Further, in the top view image 5b, a slide bar 82 for instructing a direction of backward traveling of the vehicle 10a towing the trailer 60a is displayed. By sliding the slide bar 82 in arrow directions, the user can instruct the direction of backward traveling of the vehicle 10a towing the trailer 60a within a range of, for example, 30 degrees to the left rear to 30 degrees to the right rear.

### Generation Example of Rear Image

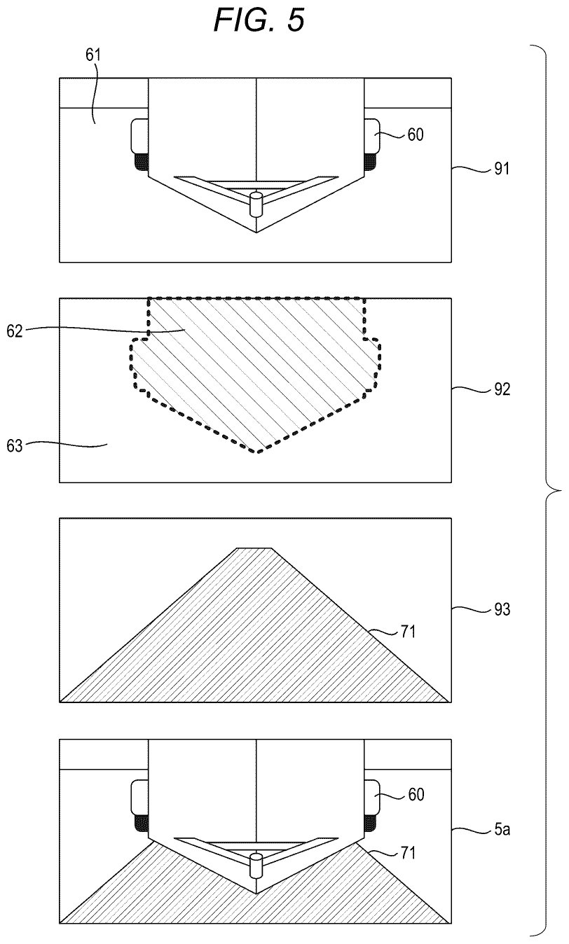

FIG. 5 is a diagram illustrating an example of generation of the rear image 5a illustrated in FIG. 4. As illustrated in FIG. 5, the display control unit 56 of the vehicle 10 generates a rear external environment image 91 of the vehicle 10 based on an external environment image captured by the rear camera 12Rr. The rear external environment image 91 includes an image of the trailer 60 towed by the vehicle 10, an image of a background 61 of the vehicle 10, and the like.

The display control unit 56 generates a range-divided image 92 based on the rear external environment image 91, including a first range 62 showing a region in which the trailer 60 is displayed and a second range 63 showing a region in the rear external environment image 91 excluding the first range 62.

The display control unit 56 generates a guide image 93 showing the guidance route image 71 for the vehicle 10 towing the trailer 60. The guidance route image 71 is an image that guides the vehicle 10 towing the trailer 60 along a direction of backward traveling from a current position to a target parking position.

The display control unit 56 generates the rear image 5a on which the guidance route image 71 is display and superimposed, based on the generated rear external environment image 91, the range-divided image 92, and the guide image 93. The rear image 5a illustrated in FIG. 5, as the rear image 5a illustrated in FIG. 4, is an image in which the guidance route image 71 is displayed only in the region excluding the image of the trailer 60 (second range) and is not displayed in the region in which the trailer 60 is displayed (first range).

### Display Processing for Rear Image

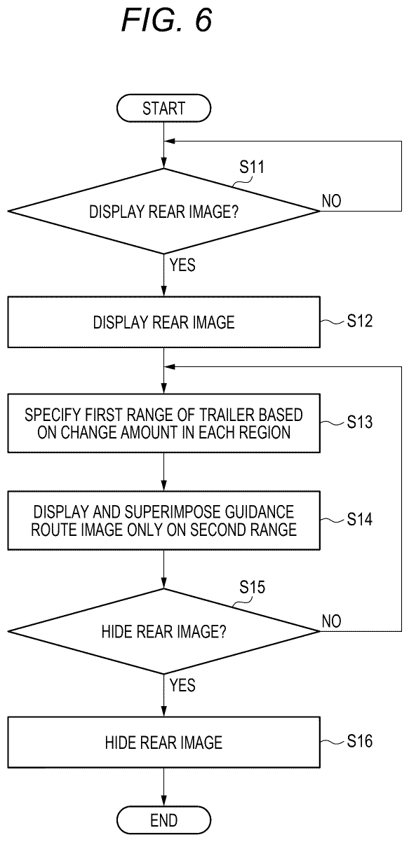

FIG. 6 is a flowchart illustrating an example of display processing for the rear image when the vehicle 10 travels backward.

The display control unit 56 determines whether to display the rear image of the vehicle 10 acquired by the external environment information acquisition unit 55 on the touch panel 42 of the navigation device 18 (step S11). The rear image is displayed if the gear position of the vehicle 10 is in Reverse. The display control unit 56 detects whether the gear position is in Reverse and determines whether to display the rear image. The display control unit 56 may also determine whether to display the rear image depending on whether a navigation mode of the navigation device 18 is turned on, for example.

In step S11, if the rear image is not to be displayed, that is, if the gear position is not in Reverse (step S11: No), the display control unit 56 repeats the processing of step S11. In step S11, if the rear image is to be displayed, that is, if the gear position is in Reverse (step S11: Yes), the display control unit 56 displays the rear image on the touch panel 42 (step S12).

Next, the display control unit 56 detects the change amount in each region of the rear image, and specifies the first range in which the trailer 60 is displayed based on the detection result (step S13). For example, the display control unit 56 detects a region in which the change amount per unit time of each pixel is a predetermined value or less, and specifies the detected region as the first range in which the trailer 60 is displayed. The display control unit 56 specifies a region in the rear image excluding the first range as the second range.

Next, the display control unit 56 displays the guidance route image showing the guidance route for the vehicle 10 and the trailer 60 in a superimposed manner only on the second range excluding the first range specified in step S13 (step S14).

The display control unit 56 determines whether the rear image of the vehicle 10 displayed on the touch panel 42 is not displayed, that is, whether the gear position is not in Reverse (step S15).

In step S15, if the rear image is not to be non-displayed (step S15: No), the display control unit 56 returns to step S13 and executes each processing. In step S15, if the rear image is to be non-displayed (step S15: Yes), the display control unit 56 controls not to display the rear image on the touch panel 42 (step S16).

Note that generation processing for the guidance route image to be displayed in a superimposed manner is executed separately from the present processing.

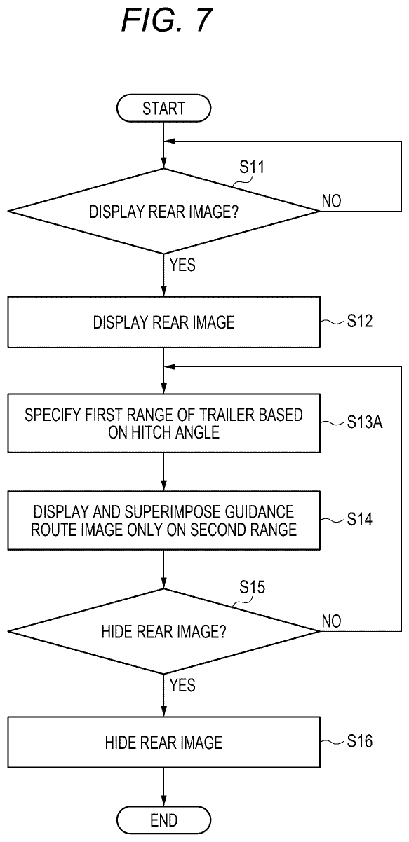

FIG. 7 is a flowchart illustrating a modification of the display processing of the rear image when the vehicle 10 travels backward. As illustrated in FIG. 7, processing from step S11 to step S12 is similar to the processing from step S11 to step S12 described with reference to FIG. 6.

Next, the display control unit 56 specifies the first range in which the trailer 60 is displayed based on the hitch angle of the hitch ball coupling the vehicle 10 to the trailer 60, that is, the relative angle between the vehicle 10 and the trailer 60 (step S13A). The display control unit 56 detects the hitch angle by a sensor, and reads out the first range associated with the detected hitch angle, for example, from a correspondence information table, to specify the first range. The display control unit 56 specifies a region in the rear image excluding the first range as the second range.

Note that processing from step S14 to step S16 is the same as the processing from step S14 to step S16 described with reference to FIG. 6.

### Generation Example of Rear Image

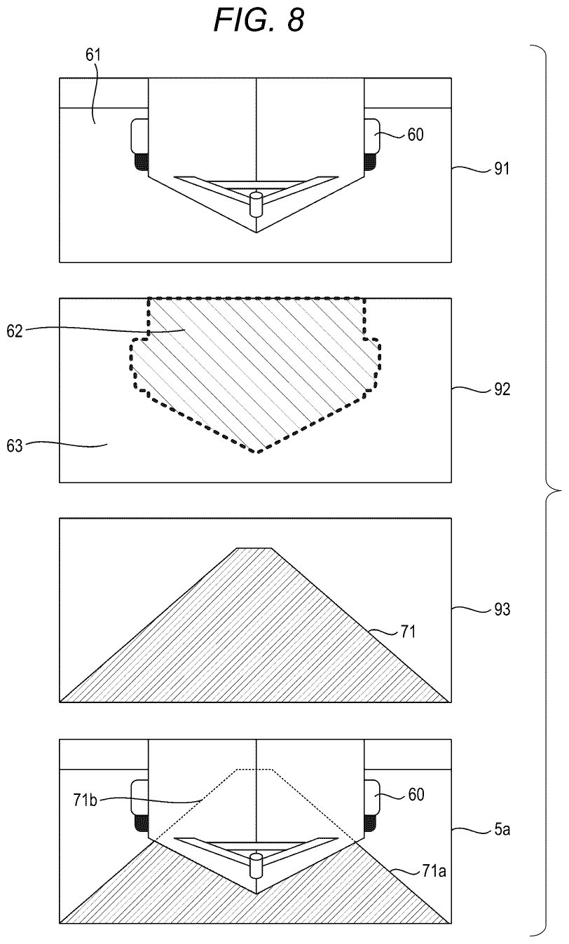

FIG. 8 is a diagram illustrating a modification of the generation of the rear image 5a illustrated in FIG. 4. As illustrated in FIG. 8, the control by the display control unit 56 to generate the rear external environment image 91, the range-divided image 92, and the guide image 93 is similar to the generation example of the rear image 5a described with reference to FIG. 5.

The display control unit 56 generates the rear image 5a on which guidance route images 71a and 71b are display and superimposed, based on the generated rear external environment image 91, the range-divided image 92, and the guide image 93. In the rear image 5a illustrated in FIG. 8, the guidance route image 71a is displayed in a region excluding the image of the trailer 60 (second range), which is similar to the mode of displaying the guidance route image 71 in the second range in the generation example of FIG. 5. On the other hand, the guidance route image 71b, which has lower visibility than the guidance route image 71a in the second range, is displayed in the region in which the trailer 60 is displayed (first range), which is different from the generation example of FIG. 5 in which the guidance route image is not displayed in the first range. The display control unit 56 displays the guidance route image 71b outlined with, for example, a dashed line, in the first range in which the trailer 60 is displayed.

In this way, when the control device (control ECU 20) in the embodiment of the present disclosure displays the guidance route image 71 for guiding the backward traveling of the vehicle 10 and the trailer 60 in a manner of being superimposed on the rear image 5a of the vehicle 10 towing the trailer 60, the control device displays the guidance route image 71 displayed superimposed on the first range of the rear image 5a in which the trailer 60 is displayed, and the guidance route image 71 displayed superimposed on the second range excluding the first range, in different superposition modes. With this configuration, for example, as illustrated in FIG. 4, the user can easily understand that the guidance route image 71 displayed superimposed on the region between the towing vehicle 10 and the towed trailer 60 (the region in the second range) continuously extends to the region below the trailer 60. As a result, when the user sees the rear image 5a on which the guidance route image 71 is superimposed, the user can see the rear image 5a without any discomfort.

According to the control device, the guidance route image 71 (71b) is superimposed on the first range in which the trailer 60 is displayed such that the guidance route image 71 (71b) displayed superimposed on the first range has lower visibility than the guidance route image 71 (71a) displayed superimposed on the second range in which the trailer 60 is not displayed. In this way, the user can distinguish and recognize the guidance route image 71 (71a) displayed superimposed on the second range and the guidance route image 71 (71b) that is continued from the guidance route image 71 (71a) and extends to the region below the trailer 60 without any discomfort.

According to the control device, the first range is specified based on the change amount in pixel value in each region of the rear image 5a. With this configuration, the region with a small change amount can be specified as the region in which the trailer 60 is displayed (first range), and the region with a large change amount can be specified as the region of the background around the trailer 60 (second range). In this way, the first range can be accurately specified, and the guidance route image 71 can be appropriately displayed in a superimposed manner.

According to the control device, the first range is specified based on the relative angle between the vehicle 10 and the trailer 60 towed by the vehicle 10. According to this configuration, the relative angle (hitch angle) of the trailer with respect to the vehicle 10 is detected, and the correspondence information of the first range associated with the hitch angle is read from the table, so that it is possible to easily specify the range in the rear image 5a in which the trailer 60 is displayed.

The control method described in the above embodiment may be implemented by executing a control program prepared in advance on a computer. The control program is stored in a computer-readable storage medium and executed by being read from the storage medium. Further, the control program may be provided in a form stored in a non-transitory storage medium such as a flash memory, or may be provided via a network such as the Internet. The computer that executes the control program may be provided in the control device, may be provided in an electronic device such as a smartphone, a tablet terminal, or a personal computer that can communicate with the control device, or may be provided in a server device that can communicate with the control device and the electronic device.

Although the embodiment of the present disclosure has been described above, the present invention is not limited to the above-described embodiment, and modifications, improvements, and the like can be appropriately made.

In the present specification, at least the following matters are described. Although corresponding constituent elements or the like in the above-described embodiment are shown in parentheses, the present invention is not limited thereto.
(1) A control device (control ECU 20), including a processor (external environment information acquisition unit 55, display control unit 56) configured to:
acquire external environment information of a towing vehicle (vehicle 10) towing a towed vehicle (trailer 60); and
control to display a guidance route image (guidance route image 71) showing a guidance route for at least one of the towing vehicle and the towed vehicle, the guidance route image being superimposed on a peripheral image (peripheral image 5) of the towing vehicle based on the external environment information, in which
the processor controls a superposition mode of the guidance route image to be different between a first range (first range 62) of the peripheral image in which the towed vehicle is displayed and a second range (second range 63) of the peripheral image excluding the first range.
According to (1), by controlling the display mode of the guidance route image superimposed on the first range in which the towed vehicle is displayed to be different from the display mode of the guidance route image superimposed on the second range excluding the first range, discomfort due to the displaying of the guidance route image in a superimposed manner can be reduced.
(2) The control device according to (1), in which
the processor superimposes the guidance route image on the first range in a mode such that a visibility of the guidance route image in the first range is lower than a visibility of the guidance route image in the second range.
As in (2), by reducing the visibility of the displayed guidance route image superimposed on the first range in which the towed vehicle is displayed, the discomfort due to the displaying of the guidance route image in a superimposed manner can be reduced.
(3) The control device according to (2), in which
the processor controls not to display the guidance route image in the first range.
As in (3), by non-display of the guidance route image that is superimposed on the first range in which the towed vehicle is displayed, the discomfort due to the displaying of the guidance route image in a superimposed manner can be reduced.
(4) The control device according to any one of (1) to (3), in which
the guidance route is a route from a current position of at least one of the towing vehicle and the towed vehicle to a target parking position of at least one of the towing vehicle and the towed vehicle.
As in (4), the guidance route displayed superimposed on the peripheral image is preferably a route from the current position of the towing vehicle and the towed vehicle to the target parking position.
(5) The control device according to any one of (1) to (4), in which
the guidance route is a route based on specification information of the towed vehicle and a relative angle between the towing vehicle and the towed vehicle.
According to (5), an appropriate guidance route can be generated by using the specification information of the towed vehicle and the relative angle between the towing vehicle and the towed vehicle.
(6) The control device according to any one of (1) to (5), in which
the processor specifies the first range based on a change amount in each region of the peripheral image.
According to (6), by specifying the first range in which the towed vehicle is displayed based on the change amount in each region in the peripheral image, it is possible to specify the first range accurately.
(7) The control device according to any one of (1) to (5), in which
the processor specifies the first range based on a relative angle between the towing vehicle and the towed vehicle.
According to (7), by specifying the first range in which the towed vehicle is displayed based on the relative angle between the towing vehicle and the towed vehicle, it is possible to specify the first range accurately.
(8) The control device according to any one of (1) to (7), in which the processor repeatedly updates the first range and the second range.
As in (8), by repeatedly updating the first range and the second range, the guidance route image can be appropriately displayed in a superimposed manner even during towing and moving.
(9) A control method, in which
a processor of a control device is configured to:
   acquire external environment information of a towing vehicle towing a towed vehicle;
   control to display a guidance route image showing a guidance route for at least one of the towing vehicle and the towed vehicle, the guidance route image being superimposed on a peripheral image of the towing vehicle based on the external environment information; and
   control a superposition mode of the guidance route image to be different between a first range of the peripheral image in which the towed vehicle is displayed and a second range of the peripheral image excluding the first range.
According to (9), by controlling the display mode of the guidance route image superimposed on the first range in which the towed vehicle is displayed to be different from the display mode of the guidance route image superimposed on a range excluding the first range, discomfort due to the displaying of the guidance route image in a superimposed manner can be reduced.
(10) A non-transitory computer-readable storage medium storing a control program that causes a processor of a control device to:
acquire external environment information of a towing vehicle towing a towed vehicle;
control to display a guidance route image showing a guidance route for at least one of the towing vehicle and the towed vehicle, the guidance route image being superimposed on a peripheral image of the towing vehicle based on the external environment information; and
control a superposition mode of the guidance route image to be different between a first range of the peripheral image in which the towed vehicle is displayed and a second range of the peripheral image excluding the first range.
According to (10), by controlling the display mode of the guidance route image superimposed on the first range in which the towed vehicle is displayed to be different from the display mode of the guidance route image superimposed on a range excluding the first range, discomfort due to the displaying of the guidance route image in a superimposed manner can be reduced.

What is claimed is:

1. A control device, comprising a processor configured to:
acquire external environment information of a towing vehicle towing a towed vehicle; and
control to display a guidance route image showing a guidance route for at least one of the towing vehicle and the towed vehicle, the guidance route image being superimposed on a peripheral image of the towing vehicle based on the external environment information, wherein
the processor controls a superposition mode of the guidance route image to be different between a first range of the peripheral image in which the towed vehicle is displayed and a second range of the peripheral image excluding the first range.

2. The control device according to claim 1, wherein
the processor superimposes the guidance route image on the first range in a mode such that a visibility of the guidance route image in the first range is lower than a visibility of the guidance route image in the second range.

3. The control device according to claim 2, wherein
the processor controls not to display the guidance route image in the first range.

4. The control device according to claim 1, wherein
the guidance route is a route from a current position of at least one of the towing vehicle and the towed vehicle to a target parking position of at least one of the towing vehicle and the towed vehicle.

5. The control device according to claim 1, wherein
the guidance route is a route based on specification information of the towed vehicle and a relative angle between the towing vehicle and the towed vehicle.

6. The control device according to claim 1, wherein
the processor specifies the first range based on a change amount in each region of the peripheral image.

7. The control device according to claim 1, wherein
the processor specifies the first range based on a relative angle between the towing vehicle and the towed vehicle.

8. The control device according to claim 1, wherein
the processor repeatedly updates the first range and the second range.

9. A control method, wherein
a processor of a control device is configured to:
acquire external environment information of a towing vehicle towing a towed vehicle;
control to display a guidance route image showing a guidance route for at least one of the towing vehicle and the towed vehicle, the guidance route image being superimposed on a peripheral image of the towing vehicle based on the external environment information; and
control a superposition mode of the guidance route image to be different between a first range of the peripheral image in which the towed vehicle is displayed and a second range of the peripheral image excluding the first range.

10. A non-transitory computer-readable storage medium storing a control program that causes a processor of a control device to:
acquire external environment information of a towing vehicle towing a towed vehicle;
control to display a guidance route image showing a guidance route for at least one of the towing vehicle and the towed vehicle, the guidance route image being superimposed on a peripheral image of the towing vehicle based on the external environment information; and
control a superposition mode of the guidance route image to be different between a first range of the peripheral image in which the towed vehicle is displayed and a second range of the peripheral image excluding the first range.
